(19) United States
(12) Patent Application Publication
(10) Pub. No.: US 2024/0184857 A1
(43) Pub. Date: Jun. 6, 2024

(54) DEVICE TYPE CLASSIFICATION BASED ON USAGE PATTERNS

(71) Applicant: VEEGO SOFTWARE LTD., Ramat Gan (IL)

(72) Inventors: Sergey VOLKOVICH, Rehovot (IL); Ronen KONDRATOVSKY, Petah Tikva (IL); Reffael CASPI, Tel Aviv (IL)

(21) Appl. No.: 18/527,322

(22) Filed: Dec. 3, 2023

Related U.S. Application Data
(60) Provisional application No. 63/430,127, filed on Dec. 5, 2022.

(51) Int. Cl. G06F 18/2415; G06F 18/22

(52) U.S. Cl. CPC G06F 18/2415; G06F 18/22

(57) ABSTRACT

A computer-implemented method comprising: receiving, at a wireless network interface, telemetry data from a plurality of uniquely-identified end-devices in multiple communication networks, wherein the telemetry data is measured with respect to each of the end-devices over a one or more measuring periods of a predefined duration; processing the telemetry data to calculate features indicating usage patterns associated with each of the end-devices; and at a training stage, training a machine learning model on a training dataset comprising: (i) the features indicating usage patterns associated with each of the end-devices, and (ii) labels indicating one or more attributes associated with each of the end-devices, to obtain a trained machine learning classifier configured to predict the one or more attributes with respect to an unknown target end-device, by applying the trained machine learning model to telemetry data obtained from the unknown target end-device.

### CROSS-REFERENCE TO RELATED APPLICATIONS

This application claims the benefit of priority from U.S. Provisional Patent Application No. 63/430,127, filed Dec. 5, 2022 entitled, “DEVICE TYPE CLASSIFICATION BASED ON USAGE PATTERNS,” the contents of which are hereby incorporated by reference in their entirety.

### FIELD OF THE INVENTION

The invention relates to the field of computer networks and machine learning.

### BACKGROUND

Computer networks, such as home or office Wi-Fi networks, may service many different device types, from traditional computing systems, to smart phones, tablets, smart watches, smart televisions, printers, scanners, and Internet of Things (IOT) devices.

Different device types have different usage patterns, and hence different Quality of Service (QOS) requirements, in terms of bandwidth, packet loss, delay, jitter (i.e., variations in delay), and best-effort options. Thus, the ability to classify device type can help in recognizing service issues affecting a device within a Wi-Fi network.

Accordingly, to properly address the challenges of varying QoS requirements, and to be able to manage network resources efficiently, it is vital for Internet Service Providers (ISPs) to be able to recognize different device types utilizing network resources.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

There is provided, in an embodiment, a system comprising at least one hardware processor; and a non-transitory computer-readable storage medium having stored thereon program instructions, the program instructions executable by the at least one hardware processor to: receive, at a wireless network interface, telemetry data from a plurality of uniquely-identified end-devices in multiple communication networks, wherein the telemetry data is captured with respect to each of the end-devices over one or more measuring periods of a predefined duration, process the telemetry data to calculate features indicating usage patterns associated with each of the end-devices, and at a training stage, train a machine learning model on a training dataset comprising: (i) the features indicating usage patterns associated with each of the end-devices, and (ii) labels indicating one or more attributes associated with each of the end-devices, to obtain a trained machine learning classifier configured to predict the one or more attributes with respect to an unknown target end-device, by applying the trained machine learning model to telemetry data obtained from the unknown target end-device.

There is also provided, in an embodiment, a computer-implemented method comprising: receiving, at a wireless network interface, telemetry data from a plurality of uniquely-identified end-devices in multiple communication networks, wherein the telemetry data is measured with respect to each of the end-devices over a one or more measuring periods of a predefined duration; processing the telemetry data to calculate features indicating usage patterns associated with each of the end-devices; and at a training stage, training a machine learning model on a training dataset comprising: (i) the features indicating usage patterns associated with each of the end-devices, and (ii) labels indicating one or more attributes associated with each of the end-devices, to obtain a trained machine learning classifier configured to predict the one or more attributes with respect to an unknown target end-device, by applying the trained machine learning model to telemetry data obtained from the unknown target end-device.

There is further provided, in an embodiment, a computer program product comprising a non-transitory computer-readable storage medium having program instructions embodied therewith, the program instructions executable by at least one hardware processor to: receive, at a wireless network interface, telemetry data from a plurality of uniquely-identified end-devices in multiple communication networks, wherein the telemetry data is captured with respect to each of the end-devices over one or more measuring periods of a predefined duration; process the telemetry data to calculate features indicating usage patterns associated with each of the end-devices; and (i) at a training stage, train a machine learning model on a training dataset comprising: (ii) the features indicating usage patterns associated with each of the end-devices, and labels indicating one or more attributes associated with each of the end-devices, to obtain a trained machine learning classifier configured to predict the one or more attributes with respect to an unknown target end-device, by applying the trained machine learning model to telemetry data obtained from the unknown target end-device.

In some embodiments, the attributes are selected from the group consisting of: type of end-device, manufacture of end-device, make or brand of end-device, model of end-device, operating system of end-device, or operating system version of end-device.

In some embodiments, the features indicating usage pattern with respect to each of the end-devices are calculated based on at least one of the following usage categories: total usage time of the end-device during each of the measuring periods; total usage time of the end-device during each of the measuring periods, separately with respect to each one of a predefined set of service categories; number of instances of usage of the end-device during each of the measuring periods; or number of instances of usage of the end-device during each of the measuring periods, separately with respect to each one of the predefined set of service categories.

In some embodiments, the predefined set of service categories is selected from the group consisting of: media streaming, file downloading, file uploading, online gaming, conferencing, social network usage, internet browsing, VPN session, music streaming, electronic mail usage, or remote desktop session.

In some embodiments, the training dataset further comprises features indicating one or more wireless link metrics associated with each of the end-devices, wherein the wireless link metrics are selected from the group consisting of: received signal strength indication (RSSI), Wi-Fi standard, Wi-Fi RF band, Wi-Fi channel, Wi-Fi channel bandwidth, Wi-Fi channel bitrate, retransmission rate, failure rate, Wi-Fi channel load, Wi-Fi channel interference, or Wi-Fi channel background noise.

In some embodiments, the training dataset further comprises features indicating, with respect to each of the end-devices, one or more event categories occurring during each of the measuring periods, wherein the event categories are selected from the group consisting of: count and number of instances of disconnections during each of the measuring periods, authentication failures during each of the measuring periods, ADDBA requests during each of the measuring periods, and count and duration of instances of bitrate or packet rate falling below a predetermined threshold during each of the measuring periods.

In some embodiments, the predefined duration is selected from the group consisting of the following time periods: 1 hour or 24 hours.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIG. 1 illustrates an exemplary network environment which may provide for machine learning-based automated, real-time classification of end-devices, in accordance with various aspects of the present disclosure;

FIG. 2 shows a block diagram of an exemplary system for machine learning-based automated, real-time classification of end-devices, in accordance with various aspects of the present disclosure;

FIG. 3 illustrates the functional steps in a method for training a machine learning model to perform automated, real-time classification of end-devices, in accordance with various aspects of the present disclosure;

FIG. 4 provides an overview of a pipeline for training a machine learning model to perform automated, real-time classification of end-devices, in accordance with various aspects of the present disclosure;

FIG. 5 illustrates the functional steps in a method for inferencing a trained machine learning classifier to perform automated, real-time classification of end-devices, in accordance with various aspects of the present disclosure; and

FIG. 6 illustrates an inferencing pipeline of a machine learning classifier of the present disclosure, which performs automated, real-time classification of end-devices, in accordance with various aspects of the present disclosure.

### DETAILED DESCRIPTION

Disclosed herein is a technique, embodied in a system, computer-implemented method, and computer program product, which provides for machine learning-based automated, real-time classification of end-devices. In some embodiments, the present machine learning model may be configured to predict an attribute of a target unknown device, based on features associated with captured telemetry data, wherein the predicted attribute may be one or more of the following device attribute categories:
Device type (e.g., desktop computer, laptop computer, smartphone, tablet, etc.).
Device manufacture (e.g., Apple, Samsung).
Device make or brand (e.g., iPhone, Galaxy).
Device model (e.g., iPhone 13, iPhone 14).
Device operating system (e.g., iOS, Android).
Device operating system version (e.g. iOS 15, iOS 16).

As used herein, the terms ‘device classification,’ ‘device type classification,’ ‘device profiling,’ or ‘device fingerprinting,’ refer broadly to a process for determining or predicting one or more attributes of a device of interest, within the context of a communication network. As used herein, ‘device attribute,’ refers broadly to any type, class, category, model or a related attribute of an end-device, which may be any desktop, laptop, mobile, handheld, body-worn, or stationary computing device.

As noted above, classification of end-devices is an important component for advanced network management tasks by Internet Service Providers (ISPs) and content providers, to allow for efficient allocation of resources, as well as QoS and network security management. For example, in some cases, there are known underlying issues which affect all devices of a particular type or model. In other cases, the solution to a technical problem affecting a device may be dependent on the type of device in question. Accordingly, it is helpful for ISPs to be able to determine the type or category of device in question, as a first step to resolving service issue.

In a non-limiting example, in the context of residential Wi-Fi networks, QoS variability experienced by client devices drives many complaints to ISPs. However, the performance of the home or residential network is largely beyond the access and control of the ISPs. Poor performance from Wi-Fi connected devices may be caused by a variety of factors, such as devices being too far from a wireless router or AP, firmware updates pushed by vendors which can affect device performance, router or AP being turned off or not working properly, the router or AP itself receiving poor service from the external network, interference from other equipment within the home, or authentication issues between networked devices and the router or AP. Thus, in many cases, an important first step in determining a cause for poor service is identifying the type or category of device in question, because different device types may require a different set of service attributes to enable a reliable and stable connection.

However, several factors combine to make device type or category classification a challenging task. These factors include, but are not limited to:
Regulatory and user-imposed privacy requirements, which may limit the ability of enterprises to monitor network traffic in a way that may reveal device-level information;
a growing trend of data encryption of network traffic, which randomizes the original data in a way which limits the ability to detect discriminative patterns to aid in classification; and
the ever-increasing number of different types of devices on a network.

Accordingly, embodiments of the present disclosure include a machine learning model configured to perform device type and/or model classification. In some embodiments, the present machine learning model is trained on a training dataset comprising captured telemetry data from a plurality of communications networks, wherein the traffic telemetry data are associated with various types and/or models of devices operating within the networks. The device types may be any one or more of:
Computing systems: Desktop computer, laptop computer, computer server, virtual machine, processing unit, network attached storage device, etc.
Mobile devices: Cellular phone, smart phone, tablet.
Wearable devices: Smart watch, VR headset, smart glasses.
Media devices: Media player, game console, AV receiver, MP3 player, disc Player, VOIP device, eBook reader, smart camera, streaming dongle, cable box.
Network devices: Router, gateway device, switch, Wi-Fi extender.
Other: Industrial devices, controllers, sensors, automotive devices, circuit boards, VPN devices, touch panels, IoT devices, smart appliances, smart plugs, voice assistants, lighting devices, smart doorbells, printers, scanners, smart thermostats, smart sprinkler systems, security systems, smart smoke detectors, smart lock systems, smart utility meters.

Accordingly, in some embodiments, the present disclosure provides for a machine learning-based framework for training a machine learning model that can receive network traffic telemetry data captured over a network interface, and classify the traffic telemetry data as associated with a particular device type and/or model. For example, a trained machine learning model of the present disclosure may be inferenced on network traffic telemetry data from a network interface, to classify the traffic as associated with a particular device type, such as a computing system, a smartphone, a tablet, a smart watch, a smart television, a game console, a printer, a scanner, and/or an Internet of Things (IOT) device.

In some embodiments, the network traffic telemetry data are associated with specific types of service categories accessed by the devices in question, such as media streaming, file downloading, file uploading, online gaming, conferencing, social network usage, internet browsing, VPN session, music streaming, electronic mail usage, and/or remote desktop session. In some embodiments, the network traffic telemetry data and associated service categories represent usage patterns over time of the devices operating within the plurality of communications networks from which the telemetry data are taken.

In some embodiments, a training dataset of the present disclosure may also include data representing additional features with respect to the network traffic telemetry data, including, but not limited to, packets-in and packet-out rates; bytes-in and bytes-out rates; packet inter-arrival times; upload and download packet size and rates statistics; various ratios between the rate of download to upload packets, and/or in-bytes rate to out-bytes rates; type and number of communication protocols used; type of contacted servers; source and destination port numbers; type and number of used cyphersuites, extension, and key lengths; and/or number of disconnections of a device from the network's AP.

In some embodiments, the present disclosure provides for training a machine learning model using a training dataset comprising a set of specified features calculated from network traffic telemetry data captured from a plurality of communications networks. In some embodiments, a training dataset of the present disclosure may be constructed from network traffic telemetry data captured over multiple data sessions in a plurality of communications networks, wherein the multiple data sessions may be associated with two or more types of devices. Thus, in some embodiments, such a dataset may comprise features calculated from data session instances associated with two or more types of devices or models, e.g., features calculated from data session instances associated with 2, 3, 4, 5, 10, 15, or more types of devices or models.

In some embodiments, the present disclosure provides for capturing the network traffic telemetry data over specified usage periods of the associated devices. For example, network traffic telemetry data may be captured for each device type over a predefined measuring period, such as between 1 minute and 365 days of usage, e.g., 1 hour or 24 hours of usage. In some embodiments, a specified period of usage time may be a continuous period of usage, e.g., a continuous 24 hours representing usage of the device throughout all hours of the day.

In some embodiments, network traffic telemetry data may be captured for each device type over the same specified period of time (e.g., 24 hours), separately with respect to each one of a predefined set of service categories accessed by the device in question, such as media streaming, file downloading, file uploading, online gaming, conferencing, social network usage, internet browsing, VPN session, music streaming, electronic mail usage, and/or remote desktop session.

In some embodiments, the present disclosure provides for analyzing and processing the network traffic telemetry data, to extract one or more categories of network traffic telemetry data features. In some embodiments, the extracted features may include, but are not limited to, a sum total of usage time (measured, e.g., in seconds, minutes, hours, etc.) for each device type or model, separately with respect to each one of the predefined set of service categories, e.g., media streaming, file downloading, file uploading, online gaming, conferencing, social network usage, internet browsing, VPN session, music streaming, electronic mail usage, and/or remote desktop session. In some embodiments, the extracted features may include, but are not limited to, a count of the number of instances of usage for each device type or model, separately with respect to each one of the predefined set of service categories, e.g., media streaming, file downloading, file uploading, online gaming, conferencing, social network usage, internet browsing, VPN session, music streaming, electronic mail usage, and/or remote desktop session. In some embodiments, the extracted features may include, but are not limited to, a count of the number of instances of usage, as well as sum total of usage time (measured, e.g., in seconds, minutes, hours, etc.) for each device type or model in all of the predefined service categories.

In some embodiments, a training dataset of the present disclosure may also include data representing wireless link metrics associated with the network traffic telemetry data, such as, but not limited to:
Physical layer rate which relates to the transfer rate on the physical layer of the wireless link.
Signal strength, e.g., received signal strength indication (RSSI).
Wireless link retransmissions and failures.
Wireless link bitrate.
Channel metrics, including transmission protocol, bandwidth, channel utilization, bitrate.
Clear Channel Assessment (CCA), including status, load, interferences, and background noise.
Data traffic session events, such as count and number of instances of disconnections and disconnections with respect to a specified one of a predefined set of service categories, authentication failures, ADDBA requests, and count and duration of instances of bitrate or packet rate falling below a predetermined threshold.

In some embodiments, the present disclosure provides for obtaining wireless link metrics associated with the network traffic telemetry data representing usage periods of each of the associated devices. For example, wireless link metrics may be determined for each device type over a predefined measuring period, such as between 1 minute and 365 days of usage, e.g., 24 hours of usage. In some embodiments, a specified period of usage time may be a continuous period of usage, e.g., a continuous 24 hours representing usage of the device throughout all hours of the day. In some embodiments, different individual wireless link metrics may be determined over different periods of time.

In some embodiments, the present disclosure provides for analyzing and processing at least one of the wireless link metrics, to extract, for each particular device type or model, one or more categories of wireless link metrics features associated therewith, including, but not limited to, hourly minimum and maximum values, the difference between the minimum and maximum values, and the difference between the minimum and maximum values divided by their mean. The categories of wireless link metrics features may also include daily features, such as the count of minimum, maximum, and mean of nonzero values, and the standard deviation of the nonzero values.

In some embodiments, a training dataset of the present disclosure may also include data representing additional properties associated with at least some of the devices, including, but not limited to, Internet Protocol (IP) addresses, Media Access Control (MAC) addresses, open port data, Dynamic Host Control Protocol (DHCP) data, Hypertext Transfer Protocol (HTTP) data, multicast Domain Name Service (mDNS), DNS data, DNS-SD data, Universal Plug and Play (UPnP) data, and File Transfer Protocol (FTP) data. In some embodiments, the MAC address can be used to identify a vendor. The list of open ports on a device can be used to identify running services on the device. The UPnP and mDNS data can identify a device's manufacturer or model name, and can identify the capabilities of the device (e.g., a network storage device, printer device etc.). DHCP data identifies the host name, class ID, and a system sequence of numbers, which can be used to identify an operating system name and version running on the device. HTTP data from authentication and/or administration interfaces to a device can be used to assist in identifying the type of device.

In some embodiments, one or more data preprocessing operations may be applied to the raw data and/or calculated and extracted features, comprising at least one of data cleaning/filtering, data normalizing, data quality control, and/or any other suitable preprocessing method or technique. In some embodiments, some data preprocessing operations may occur before and/or after the feature extraction stage. In some embodiments, a data preprocessing stage may comprise a data cleaning operation configured to remove irrelevant or redundant data packets from the network traffic telemetry data, which may take place before the feature extraction stage. In some embodiments, data normalization may comprise normalization of the extracted features. In some embodiments, the preprocessing stage may also further include feature selection, dimensionality reduction, and/or any other suitable preprocessing method or technique.

In some embodiments, a training dataset of the present disclosure comprises a set of labeled examples, on which a machine learning model of the present disclosure may be trained to build a set of classification rules, to classify unseen examples. Accordingly, in some embodiments, the features extracted from each of the network traffic telemetry data may be labeled with a label indicating a “ground truth” class or category associated with the network traffic telemetry data, e.g., a specific type or model of a device that is associated with the network traffic telemetry data. In some embodiments, a training dataset of the present disclosure may be labeled using manual, semi-automated, or automated methods. For example, in some embodiments, a training dataset may comprise a portion of labeled feature sets, combined with unlabeled features.

In some embodiments, a machine learning model may be trained on the training dataset constructed as detailed above, to obtain a trained machine learning model able to classify a received unseen network traffic telemetry data as originating from one of several types or models of devices. For example, an output of a machine learning model of the present disclosure may indicate the category of device (smartphone, tablet, etc.), operating system associated with the device (e.g., iOS, Android, etc.), manufacturer (e.g., Apple, Samsung, etc.), make (e.g., iPhone, etc.), model (e.g., iPhone 5s, 6, 7, etc.), function (e.g., thermostat, temperature sensor, etc.), or any other information that can be used to categorize an endpoint device.

In some embodiments, the classification of a device by a machine learning model of the present disclosure can be of varying degrees of specificity, depending on the telemetry data included in the training dataset used to train the machine learning model, as well as the annotation and labeling scheme used to label the training dataset. For example, the device classification machine learning model of the present disclosure may determine, with a high degree of confidence, that an endpoint device is a smartphone, but may not be ablet to determine whether it is an Apple iPhone or another make or model of a smartphone. Similarly, the device classification machine learning model of the present disclosure may determine that the device is an Apple iphone, but may or may not be able to determine whether the device the exact version of the device (e.g., iPhone 10, 11, 12, etc.).

In some embodiments, a technique is disclosed herein for classification of a data traffic session over a data communications network, to identify a device type associated with the network traffic telemetry data. In a non-limiting example, a software agent hosted at a node of a data communications network (e.g., a home network access point or a remote server) monitors a data traffic session associated with, e.g., a device within the network. The software agent analyzes the network traffic telemetry data to determine a set of features associated with the data traffic session. The software agent then applies a trained machine learning model to the set of features, to classify the data traffic session as associated with a specified device type or model.

In accordance with example embodiments of the present invention, a system is further disclosed for classification of a data traffic session over a data communications network. The system comprises at least a receiver configured to receive telemetry data with respect to the data traffic session. The system further comprises a processor configured to calculate a plurality of features that characterize the data traffic session, and classify the data traffic session as associated with a specified device type or model.

In a non-limiting example, the present disclosure may operate within the context of a local area network (LAN) comprising one or more end-devices, e.g., end stations (STAs). A LAN may be connected to the Internet through an access point (AP) and/or a gateway, such as a broadband modem and/or router. In a typical LAN environment, a user may access the Internet by connecting a client device to a server on the Internet, via intermediate devices and networks. In some implementations, a client device may be connected to a LAN configured to communicate with servers on a wide area network (e.g., the Internet) via an access network. In some embodiments, a LAN may be a wireless local area network (WLAN), which includes, e.g., wireless STAs connected through a wireless AP, e.g., a wireless router. In some embodiments, STAs within a LAN can be, but are not limited to, a tablet, a desktop computer, a laptop computer, a handheld computer, a cellular telephone, a smartphone, a network appliance, a camera, a media player, a navigation device, a game console, or a combination of any these data processing devices or other data processing devices.

LANs and WLANs, as described herein, may include wired or wireless client devices connected through a wired or wireless access point or router. The LANs or WLANs of the present disclosure may include a computer network that covers a limited geographic area (e.g., a home, school, computer laboratory, an office building) using a wired or wireless distribution method. The LAN/WLAN may be connected with the access network via a broadband modem. The wide area network (WAN) may include servers, such as authentication servers, web servers, electronic messaging servers, etc., accessible to the client device. Home gateways and access points, as described herein, may perform many of the interfacing functions between the home network and an ISP's network. In a large number of cases, the role of the home gateway is combined with that of a wireless AP.

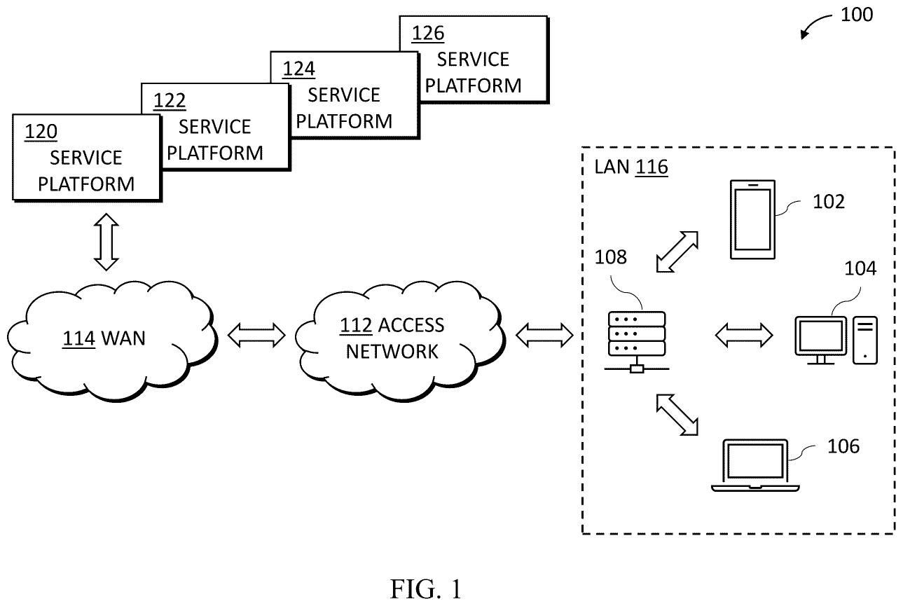

FIG. 1 illustrates an exemplary network environment 100 which may provide for classification of end-devices. Network environment 100 includes end-device or end-stations (STAs) 102, 104 and 106 communicably connected to service platforms 120-126 via local area network (LAN) 116, access network 112 and wide area network (WAN) 114. LAN 116 includes AP 108 and STAs 102-106. LAN 116 may be connected with the access network via a broadband modem.

Each of STAs 102-106 can represent various forms of computing devices. In the exemplary network environment 100 shown in FIG. 1, STA 102 is a smartphone, STA 104 is a desktop computer, and STA 106 is a laptop computer. However, STAs 102-106 can be any a handheld computer, a tablet, a cellular telephone, a smart watch, a network appliance, a camera, a media player, a navigation device, a gaming console, a printer, a scanner, and/or an Internet of Things (IOT) device.

Each of service platforms 120-126 may be a system or device having a processor, a memory, and communications capability for providing content and/or streaming services to the STAs 102-106, such as media streaming, file downloading, file uploading, online gaming, conferencing, social network usage, internet browsing, VPN session, music streaming, electronic mail usage, and/or remote desktop session. In some example aspects, each of service platforms 120-126 can be a single computing device, for example, a computer server. In other embodiments, each of service platforms 120-126 can represent more than one computing device working together to perform the actions of a server computer (e.g., cloud computing). Further, each of service platforms 120-126 can represent various forms of servers including, but not limited to an application server, a proxy server, a network server, an authentication server, an electronic messaging server, a content server, a server farm, etc., accessible to STAs 102-106.

A user of STAs 102-106 may interact with the content and/or services provided by one or more of service platforms 120-126 through a client application installed at STAs 102-106. Alternatively, the user may interact with the content and/or services provided by one or more of service platforms 120-126 through a web browser application at STAs 102-106. Communication between STAs 102-106 and one or more of service platforms 120-126 may be facilitated through LAN 116, access network 112 and/or WAN 114.

In some aspects, STAs 102-106 may communicate through a communication interface (not shown), which may include digital signal processing circuitry where necessary. The communication interface may provide for communications under various modes or protocols, for example, Global System for Mobile communication (GSM) voice calls, Short Message Service (SMS), Enhanced Messaging Service (EMS), or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA2000, or General Packet Radio System (GPRS), among others. For example, the communication may occur through a radio-frequency transceiver (not shown). In addition, short-range communication may occur, for example, using a Bluetooth, wi-fi, or other such transceiver.

WAN 114 can include, but is not limited to, a large computer network that covers a broad area (e.g., across metropolitan, regional, national or international boundaries), for example, the Internet, a private network, an enterprise network, a cellular network, or a combination thereof connecting any number of mobile clients, fixed clients, and servers. Further, WAN 114 can include, but is not limited to, any of the following network topologies, including a bus network, a star network, a ring network, a mesh network, a star-bus network, tree or hierarchical network, and the like. WAN 114 may include one or more wired or wireless network devices that facilitate device communications between STAs 102-106 and service platforms 120-126, such as switch devices, router devices, relay devices, etc., and/or may include one or more servers.

Access network 112 can include, but is not limited to, a cable access network, public switched telephone network, and/or fiber optics network to connect WAN 114 to LAN 116. Access network 112 may provide last mile access to internet. Access network 112 may include one or more routers, switches, splitters, combiners, termination systems, central offices for providing broadband services.

LAN 116 can include, but is not limited to, a computer network that covers a limited geographic area (e.g., a home, school, computer laboratory, a business enterprise, or an office building) using a wired or wireless distribution method. Client devices (e.g., STAs 102-106) may associate with an AP (e.g., AP 108) to access LAN 116 using wi-fi standards.

For exemplary purposes, LAN 116 is illustrated as including multiple STAs 102-106; however, LAN 116 may include only one of STAs 102-106. In some implementations, LAN 116 may be, or may include, one or more of a bus network, a star network, a ring network, a relay network, a mesh network, a star-bus network, a tree or hierarchical network, and the like.

AP 108 can include a network-connectable device, such as a hub, a router, a switch, a bridge, or an AP. The network-connectable device may also be a combination of devices, such as a wi-fi router that can include a combination of a router, a switch, and an AP. Other network-connectable devices can also be utilized in implementations of the subject technology. AP 108 can allow client devices (e.g., STAs 102-106) to connect to WAN 114 via access network 112.

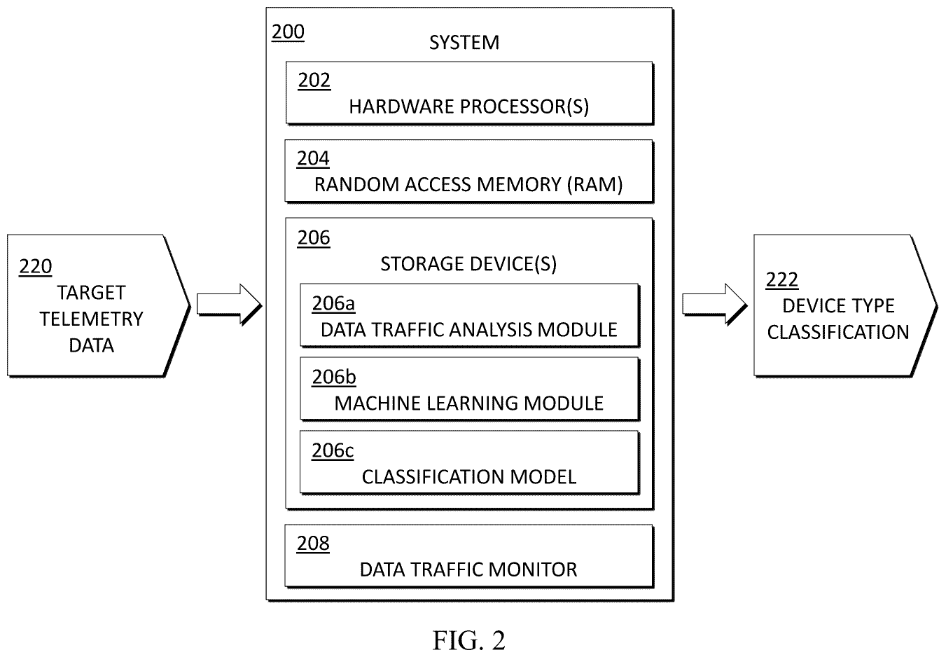

FIG. 2 shows a block diagram of an exemplary system 200 for machine learning-based automated, real-time classification of end-devices.

System 200 as described herein is only an exemplary embodiment of the present invention, and in practice may have more or fewer components than shown, may combine two or more of the components, or a may have a different configuration or arrangement of the components. The various components of system 200 may be implemented in hardware, software or a combination of both hardware and software. In various embodiments, system 200 may comprise a dedicated hardware device, or may be implement as a hardware and/or software module into an existing device, e.g., an AP, such as AP 108 within LAN 116 shown in FIG. 1.

System 200 may include one or more hardware processor(s) 202, a random-access memory (RAM) 204, one or more non-transitory computer-readable storage device(s) 206, and a data traffic monitor 208. Components of system 200 may be co-located or distributed, or the system may be configured to run as one or more cloud computing ‘instances,’ ‘containers,’ ‘virtual machines,’ or other types of encapsulated software applications, as known in the art.

Storage device(s) 206 may have stored thereon program instructions and/or components configured to operate hardware processor(s) 202. The program instructions may include one or more software modules, such as data traffic analysis module 206a, machine learning module 206b, and/or classification model 206c. The software components may include an operating system having various software components and/or drivers for controlling and managing general system tasks (e.g., memory management, storage device control, power management, etc.), and facilitating communication between various hardware and software components. System 200 may operate by loading instructions of the various software modules 206a-206c into RAM 204 as they are being executed by processor(s) 202.

The data traffic monitor 208 may be configured to continuously monitor one or more data traffic sessions over data communication networks. Data traffic monitor 208 may monitor and capture telemetry data, captured through active and/or passive probing of endpoint devices. In some embodiments, probing by data traffic monitor 208 may entail sending one or more of the following probes:
DHCP probes with helper addresses.
SPAN probes, to get messages in INIT-REBOOT and SELECTING states, use of ARP cache for IP/MAC binding, etc.
Netflow probes.
HTTP probes to obtain information such as the OS of the device, Web browser information, etc.
RADIUS probes.
SNMP to retrieve MIB object or receives traps.
DNS probes to get the Fully Qualified Domain Name (FQDN).
Active or SNMP scanning to retrieve the MAC address of a device or other types of information.

In some embodiments, telemetry data captured by data traffic monitor 208 may also include data packets, user data, or control information associated with various information channels (e.g., control channels, data channels, and information related to managing service discovery over network connections). Information received at data traffic monitor 208 may be processed and transmitted to data traffic analysis module 206a and/or to other components of system 200.

In some embodiments, data traffic monitor 208 may be software based, hardware based, or a combination of both software and hardware. Data traffic monitor 208 may comprise one or more monitoring points, which may be implemented in software and/or hardware devices distributed over a plurality of networks. In some cases, data traffic monitor 208 may be implemented by a vendor, such as an ISP, to monitor network data traffic over a backbone or access network, where the data traffic is associated with a plurality of LANs serviced by the ISP.

In some embodiments, telemetry data captured by data traffic monitor 208 originate in wired networks and/or wireless networks and virtual environments. In some examples, data traffic monitor 208 may include a circuit or circuitry for monitoring and identifying one or more attributes of a connection. In some embodiments, data traffic monitor 208 may be configured to monitor and determine, e.g., connection throughput (e.g., connection bitrate, packets per second, etc.). In some embodiments, data traffic monitor 208 may comprise a ‘sniffer’ or network analyzer designed to capture telemetry data on a network. In some embodiments, data traffic monitor 208 may be configured to capture telemetry data associated with one or more devices connected to a network. In some embodiments, network traffic monitor 208 may employ any suitable hardware and/or software tool to capture traffic telemetry data. For example, network traffic monitor 208 may be deployed to monitor one or more access networks, access points, end-devices, and/or hosts, to telemetry data associated with data flows sent to or received from the internet. In some embodiments, network traffic monitor 208 may be configured to determine a corresponding source or application associated with each captured data packet. In some embodiments, network traffic monitor 208 may be configured to timestamp each received packet, and to label each received packet with its associated source or application.

In some embodiments, data traffic analysis module 206a may be configured to receive network data traffic and to preprocess and/or process and analyze the data according to any desirable or suitable analysis technique, procedure or algorithm. In some embodiments, data traffic analysis module 206a may be configured to perform any one or more of the following: data cleaning, data filtering, data normalizing, and/or feature extraction and calculation.

In some embodiments, the instructions of machine learning module 206b may cause system 200 to receive training data, process it, and output one or more training datasets, each comprising a plurality of annotated data samples, based on one or more annotation schemes. The instructions of machine learning module 206b may further cause system 200 to train and implement one or more machine learning models, e.g., classification model 206c, using the one or more training datasets constructed by machine learning module 206b.

In some embodiments, machine learning module 206b may implement one or more machine learning models using various model architectures, e.g., convolutional neural network (CNN), recurrent neural network (RNN), or deep neural network (DNN), adversarial neural network (ANN), and/or any other suitable machine learning model architecture. The terms ‘machine learning model’ and ‘machine learning classifier’ are used interchangeably, and may be abbreviated ‘model’ or ‘classifier.’ These terms are intended to refer to any type of machine learning model which is capable of producing an output, e.g., a classification, a prediction, or generation of new data, based on a training scheme which trains a model to perform a specified prediction or classification. Classification algorithms can include linear discriminant analysis, classification and regression trees/decision tree learning/random forest modeling, nearest neighbor, support vector machine, logistic regression, generalized linear models, Naive Bayesian classification, and neural networks, among others.

In some embodiments, the instructions of classification model 206c may cause system 200 to receive, at an inference stage, input telemetry data originating from an unknown target device, and to output a classification of an end-device 222 of the input telemetry data 220.

In some embodiments, classification model 206c may be configured to execute any one or more classification algorithms with respect to received data, to generate predictions. The terms ‘classification’ and ‘prediction’ may be used herein interchangeably and are intended to refer to any type of output of a machine learning model. This output may be in the form of a class and a confidence score which indicates the certainty that input data belong to a certain class of a predetermined set of classes. Various types of machine learning models may be configured to handle different types of input and produce respective types of output; all such types are intended to be covered by present embodiments. The terms ‘class,’ ‘category,’ ‘category label,’ ‘label,’ and ‘type’ when referring to service types can be considered synonymous terms with regard to the application-level classification of network data traffic.

System 200 as described herein is only an exemplary embodiment of the present invention, and in practice may be implemented in hardware only, software only, or a combination of both hardware and software. System 200 may have more or fewer components and modules than shown, may combine two or more of the components, or may have a different configuration or arrangement of the components. System 200 may include any additional component enabling it to function as an operable computer system, such as a motherboard, data busses, power supply, a network interface card, a display, an input device (e.g., keyboard, pointing device, touch-sensitive display), etc. (not shown). Moreover, components of system 200 may be co-located or distributed, or the system may be configured to run as one or more cloud computing ‘instances,’ ‘containers,’ ‘virtual machines,’ or other types of encapsulated software applications, as known in the art. As one example, system 200 may in fact be realized by two separate but similar systems. These two systems may cooperate, such as by transmitting data from one system to the other (over a local area network, a WAN, etc.), so as to use the output of one module as input to the other module.

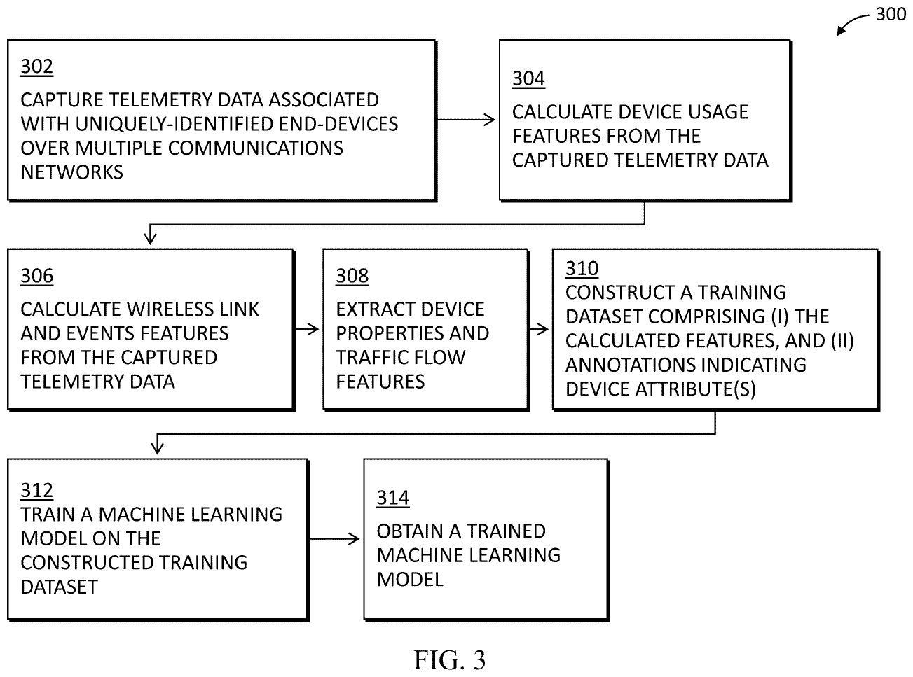

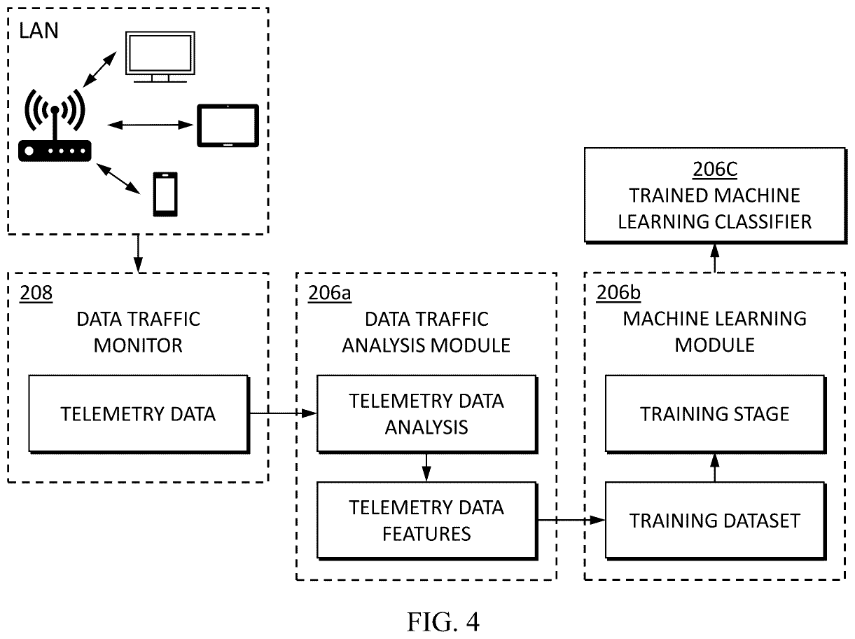

The instructions of system 200 will now be discussed with reference to the flowchart of FIG. 3, which illustrates the functional steps in a method 300 for training a machine learning model, such as classification model 206c, to perform machine learning-based automated, real-time classification of end-devices. FIG. 4 provides an overview of a pipeline for training a machine learning model of the present disclosure, according to method 300.

The various steps of method 300 may either be performed in the order they are presented or in a different order (or even in parallel), as long as the order allows for a necessary input to a certain step to be obtained from an output of an earlier step. In addition, the steps of method 300 may be performed automatically (e.g., by system 200 of FIG. 2), unless specifically stated otherwise.

Method 300 begins in step 302, wherein the instructions of data traffic monitor 208 may cause system 200 to capture telemetry data associated with data traffic flow samples over a plurality of monitored communications networks, wherein the data traffic flows are associated with uniquely-identified end-devices of various types, operating within the monitored networks.

In some embodiments, the telemetry data may be captured, with respect to each of the end-devices, over one or more predefined measuring periods of between 1 minute and 365 days. In some embodiments, the predefined measuring period is 1 hour. In some embodiments, the predefined measuring period is 24 hours.

In some embodiments, unique device identification may be based, at least in part, on a combination of device MAC address and an ID assigned to the software agent hosted on the network's AP. The device types may be any one or more of computing systems, smartphones, tablets, smart watches, game consoles, smart televisions, printers, scanners, and/or Internet of Things (IOT) devices.

In some embodiments, the instructions of data traffic monitor 208 may cause system 200 to monitor data traffic flow samples in the monitored networks associated with each unique end-device, to capture telemetry data with respect to the unique end-devices. For example, with reference to FIG. 1, an end-device, such as STA 102 operating within LAN 116, may initiate a data traffic session with one of service platforms 120-126. The data traffic session can comprise a stream of data packets. The instructions of data traffic monitor 208 may cause system 200 to monitor the data traffic session, assign to it the unique ID of the associated device STA 102, and analyze and assess the data packets included in the data traffic flow samples, as well as additional data, to capture telemetry data therefrom.

Telemetry data may include, for example, the MAC addresses of the associated devices, traffic features captured from the devices' traffic (e.g., which protocols were used, source or destination information, etc.), timing information (e.g., when the devices communicate, sleep, etc.), and/or any other information regarding the devices that can be used to infer their device types. For example, telemetry data regarding protocols used may represent the presence or absence of a certain protocol in the traffic of the device such as, but not limited to, IPV6, IPv4, IGMPv3, IGMPv2, ICMPv6, ICMP, HTTP/XML, HTTP, etc.

Similarly, the instructions of data traffic monitor 208 may cause system 200 to analyze packet headers, to capture telemetry data with respect to the monitored data traffic flow samples. For example, the instructions of data traffic monitor 208 may cause system 200 to extract the source address and/or port of the STA 102, the destination address and/or port of service platforms 120-126, the protocol(s) used by each packet included in the data traffic flow samples, the hostname of one or more service platforms 120-126, and/or other header information by analyzing the headers of included packets. Example features in the telemetry data may include, but are not limited to, Transport Layer Security (TLS) information (e.g., from a TLS handshake), such as the ciphersuite offered, User Agent information, destination hostname, TLS extensions, etc., HTTP information (e.g., URI, etc.), Domain Name System (DNS) information, ApplicationID, virtual LAN (VLAN) ID, or any other data features that can be extracted from the monitored data traffic flow samples. Further information, if available, could also include process hash information from the process on STA 102 that participates in the data traffic flow samples.

In further embodiments, the instructions of data traffic monitor 208 may cause system 200 to assess the payload of the included packets in the data traffic flow samples, to extract information about the data traffic flow samples. For example, the instructions of data traffic monitor 208 may cause system 200 to perform deep packet inspection (DPI) on one or more of the included packets, to assess the contents of the packets. Doing so may, for example, yield additional information that can be used to determine the application associated with the data traffic flow samples (e.g., the packets were sent by a web browser of STA 102, by a videoconferencing application, etc.).

In some embodiments, the instructions of data traffic monitor 208 may cause system 200 to compute any number of statistics or metrics regarding the data traffic flow samples. For example, data traffic monitor 208 may determine the start time, end time, duration, packet size(s), the distribution of bytes within a flow, etc., associated with the traffic flow by observing included packets.

In some embodiments, the instructions of data traffic monitor 208 may cause system 200 to capture telemetry data from packet header information (obtained either through operating system files or data traffic sniffing), including, e.g., the IP source, destination, and port numbers. In some embodiments, network traffic monitor 208 may employ one or more connection tracking tools (for example, tools intended for use in conjunction with a Linux operating system, such as Iptables and/or Connection Tracking System), to determine such traffic flow features. In some embodiments, such tools may provide such information with respect to application protocols such as FTP, TFTP, IRC, and PPTP. In some embodiments, such tools provide the ability to monitor and handle traffic packets at different stages, e.g., pre-routing, local input, forward, local output, and/or post-routing.

In some embodiments, the instructions of data traffic monitor 208 may cause system 200 to generate a record of the monitored traffic flow samples, which may include information about each flow sample that was observed, e.g., an application or service or service platform associated with the flow sample, characteristic properties of a flow sample (e.g., IP addresses and port numbers) as well as size-based and temporal properties (e.g., packet and byte counters). In some embodiments, network traffic monitor 208 may be further configured to timestamp received flow samples upon packet arrival.

In some embodiments, the instructions of data traffic monitor 208 may cause system 200 to measure wireless link metrics associated with the data traffic flow samples representing usage periods of each of the associated devices. For example, wireless link metrics may be determined for each unique device over a predefined measuring period, such as a period extending between 1 minute and 365 days of usage, e.g., 24 hours of usage. In some embodiments, a specified period of usage time may be a continuous period of usage, e.g., a continuous 24 hours representing usage of the device throughout all hours of the day.

In some embodiments, the instructions of data traffic monitor 208 may cause system 200 to monitor data flow samples, to capture related telemetry data from a plurality of communications networks, wherein the data traffic flow samples are associated with various types and/or models of devices operating within the networks, and wherein the monitoring is performed over specified usage periods of the associated devices. For example, the instructions of data traffic monitor 208 may cause system 200 to monitor network data traffic flow samples and to capture related telemetry data for each unique device, measured over predefined measuring period, such as between 1 minute and 365 days of usage, such as 1 hour or 24 hours of usage. In some embodiments, a specified period of usage may be a continuous period of usage, e.g., a continuous 24 hours representing usage of the device throughout all hours of the day.

In some embodiments, the instructions of data traffic monitor 208 may cause system 200 to monitor data flows to capture related telemetry data from a plurality of communications networks, wherein the data flow samples are associated with various types and/or models of devices operating within the networks, separately with respect to each one of a predefined set of service categories accessed by the device in question, wherein the service categories may include:
Media streaming,
file downloading,
file uploading,
online gaming,
conferencing,
social network usage,
internet browsing,
VPN sessions,
music streaming,
electronic mail usage, and/or
remote desktop sessions.

In some embodiments, the instructions of data traffic monitor 208 may cause system 200 to sample and/or filter the monitored data flow samples, such that only certain packets are retained and/or processed within system 200. In some embodiments, a combination of several sampling and filtering steps can be adopted to select only packets of interest, to reduce computational load of subsequent stages or processes as well as the consumption of bandwidth and memory. For example, systematic sampling may be applied, wherein only every Nth packet is selected in a periodic sampling scheme. In other example, random sampling may be applied to select packets in accordance with a random process. In some embodiments, the instructions of data traffic monitor 208 may cause system 200 to apply one or more filtering schemes, e.g., to select packets where specific fields within the packet (and/or the router state) are equal to a specified value or inside a specified value range. In other examples, packets that are used for handshake generation and do not contain any useful information about the protocol or service being used may be removed (e.g., SYN, ACK, FIN packets).

With reference back to FIG. 3, in step 304, the instructions of data traffic analysis module 206 may cause system 200 to receive the telemetry data captured in step 302, and to process the received data to calculate one or more sets of features therefrom.

In some embodiments, the features may be calculated, with respect to each of the end-devices, over one or more predefined measuring periods of between 1 minute and 365 days. In some embodiments, the predefined measuring period is 1 hour. In some embodiments, the predefined measuring period is 24 hours.

In some embodiments, the instructions of data traffic analysis module 206a may cause system 200 to classify the captured telemetry data based on a predetermined set of service types or categories associated with the telemetry data. In some embodiments, such service types or categories include media streaming, file downloading, file uploading, online gaming, conferencing, social network usage, internet browsing, VPN sessions, music streaming, electronic mail usage, and/or remote desktop sessions. For example, in some embodiments, the instructions of classification model 206c may cause system 200 to apply a trained machine learning model to classify telemetry data into one of the service categories noted above.

In some embodiments, the instructions of data traffic analysis module 206 may cause system 200 to classify the captured telemetry data based on a predetermined set of service types or categories, based on connection parameters, such as, but not limited to, domain name, IP address, and/or port numbers. In some embodiments, a domain name may be determined using a Secure Socket Layer (SSL) certificate, which provides a fully qualified domain name associated with a server as verified by a trusted third party service. For example, a reverse DNS lookup or reverse DNS resolution (rDNS) may be carried out by data traffic analysis module 206a to determine the domain name associated with an IP address. In other examples, data traffic analysis module 206a may determine port numbers associated the IP address, and/or a transport protocol, e.g., Transmission Control Protocol (TCP) and the User Datagram Protocol (UDP). In the case of port number ranges, because many internet resources use a known port or port ranges on their local host as a connection point to which other hosts may initiate communication, data traffic analysis module 206a may analyze TCP SYN packets to know the server side of a new client-server TCP connection.

In some embodiments, the instructions of data traffic analysis module 206 may cause system 200 to classify the captured telemetry data based on a predetermined set of service types or categories, based on detecting a URL or a server IP address and associating the URL or IP address with a known domain found, e.g., in repository of domain names associated with a specified category or class of service. For example, known domain names associated with media streaming may be identified and added to a database of domain name maintained by system 200, e.g., on storage device 206. In some embodiments, such classification may be further supported by, e.g., an expression or a string (e.g., a regex) which may be associated with a particular streaming application or service provider (e.g., ‘Netflix’), an expected port range associated with the service type, or an expected protocol associated with the service provider.

In some embodiments, a database of known domain names associated with the predefined service categories may be obtained using, e.g., a dedicated crawler configured to systematically browses the Internet for the purpose of identifying and indexing domain names based on a type, content, etc. A crawler typically travels over the internet and accesses resources. The crawler inspects, e.g., the content or other attributes of resources. The crawler then follows hyperlinks to other resources. The results of the crawling are then extracted into a repository, which may be queried to find content that is relevant to a particular task. Thus, for example, a URL or IP address associated with a service being provided to an STA 102-106 in LAN 116 may be matched with an entry in a domain repository maintained by system 200. In such case, the service may be determined to be a category of service associated with the matched domain name.

In some embodiments, the instructions of data traffic analysis module 206 may cause system 200 to calculate device usage-related features, by analyzing the telemetry data associated with each unique device for which telemetry data is captured in step 302. In some embodiments, the calculated usage features categories are based on the following time-dependent analyses performed by data traffic analysis module 206a, including, but not limited to:
Device usage time (measured, e.g., in seconds, minutes, hours, etc.) per measuring period (e.g., hourly, daily).
Device usage time (measured, e.g., in seconds, minutes, hours, etc.) per measuring period (e.g., hourly, daily), separately with respect to each one of the predefined set of service categories, e.g., media streaming, file downloading, file uploading, online gaming, conferencing, social network usage, internet browsing, VPN session, music streaming, electronic mail usage, and/or remote desktop session.
Count of device usage instances per measuring period (e.g., hourly, daily).
Count of device usage instances per measuring period (e.g., hourly, daily), separately with respect to each one of the predefined set of service categories, e.g., media streaming, file downloading, file uploading, online gaming, conferencing, social network usage, internet browsing, VPN session, music streaming, electronic mail usage, and/or remote desktop session.

In a non-limiting example, the instructions of data traffic analysis module 206a may cause system 200 to calculate one or more of the following features for each measuring period (which may be between 1 minute and 365 days, e.g., 24 hours), based on these time-dependent analyses:
Count of usage instances per 24 hours for each unique device.
Count of usage instances per hour for each unique device.
Total device usage time per 24 hours for each unique device.
Total device usage time per hour for each unique device.
Count of usage instances per 24 hours for each unique device, separately in each service category (media streaming, file downloading, file uploading, online gaming, conferencing, social network usage, internet browsing, VPN session, music streaming, electronic mail usage, and/or remote desktop session).
Count of usage instances per hour for each unique device, separately in each service category (media streaming, file downloading, file uploading, online gaming, conferencing, social network usage, internet browsing, VPN session, music streaming, electronic mail usage, and/or remote desktop session).
Total device usage time per 24 hours for each unique device, separately in each service category (media streaming, file downloading, file uploading, online gaming, conferencing, social network usage, internet browsing, VPN session, music streaming, electronic mail usage, and/or remote desktop session).
Total device usage time per hour for each unique device, separately in each service category (media streaming, file downloading, file uploading, online gaming, conferencing, social network usage, internet browsing, VPN session, music streaming, electronic mail usage, and/or remote desktop session).

In some embodiments, different individual usage-related features may be determined over different periods of time.

In some embodiments, the instructions of data traffic analysis module 206a may cause system 200 to further calculate one or more statistics with respect to at least one of the calculated usage-based features, including, but not limited to, mean, average, variance, standard distribution, and the like.

With continued reference to FIG. 3, in step 306, the instructions of data traffic analysis module 206a may cause system 200 to calculate, with respect to each unique device, a set of wireless link metrics associated with the network traffic telemetry data, such as, but not limited to:
Physical layer rate which relates to the transfer rate on the physical layer of the wireless link.
Signal strength, e.g., received signal strength indication (RSSI).
Wireless link retransmissions and failures.
Wireless link bitrate.
Channel metrics, including transmission protocol, bandwidth, channel utilization, bitrate.
Clear Channel Assessment (CCA), including status, load, interferences, and background noise.
Data traffic session events, count and number of instances of disconnections and disconnections with respect to a specified one of a predefined set of service categories, authentication failures, ADDBA requests, and count and duration of instances of bitrate or packet rate falling below a predetermined threshold.

In some embodiments, the wireless link metrics may be calculated, with respect to each of the end-devices, over one or more predefined measuring periods of between 1 minute and 365 days. In some embodiments, the predefined measuring period is 1 hour. In some embodiments, the predefined measuring period is 24 hours.

In some embodiments, the instructions of data traffic analysis module 206a may cause system 200 to analyze and process the wireless link metrics, to calculate, for each particular device type or model, one or more categories of wireless link metric features. For example, wireless link metrics features may be calculated based on measuring and aggregating, per measuring period (e.g., hourly, daily) the minimum values, maximum values, difference between the minimum and maximum values, mean values, variance in the values, and/or distribution of wireless link metrics.

In a non-limiting example, the instructions of data traffic analysis module 206a may cause system 200 to calculate, for each unique device, one or more of the following daily features, based on hourly aggregated wireless link metrics:
Minimum number of nonzero values per 24 hours.
Maximum number of nonzero values per 24 hours.
Average number of nonzero values per 24 hours.
Difference between the minimum and maximum number of nonzero values per 24 hours.
Ratio of the difference between the minimum and maximum number of nonzero values, to the average number of nonzero values per 24 hours.
Minimum mean of nonzero values per 24 hours.
Maximum mean of nonzero values per 24 hours.
Average of mean nonzero values per 24 hours.
Difference between the minimum mean and maximum mean of values per 24 hours.
Ratio of difference between the minimum and maximum means of values, to the average of mean values per 24 hours.
Minimum standard deviation of nonzero values per 24 hours.
Maximum standard deviation of nonzero values per 24 hours.
Average standard deviation of nonzero values per 24 hours.
Difference between the minimum and maximum standard deviation of nonzero values per 24 hours.
Ratio of difference between the minimum and maximum standard deviation of nonzero values, to the average standard deviation of nonzero values per 24 hours.

In some embodiments, different wireless link metrics features may be determined over different periods of time.

In some embodiments, the instructions of data traffic analysis module 206a may cause system 200 to further calculate one or more statistics with respect to at least one of the calculated wireless link metrics features, including, but not limited to, mean, average, variance, standard distribution, and the like.

In some embodiments, in step 308, optionally, the instructions of data traffic analysis module 206a may cause system 200 to determine additional device-specific identification features with respect to each unique device, which may provide further identification data with respect to each unique device. In a nonlimiting example, these features may include, but are not limited to:
Device brand (e.g., iPhone, iPad).
Device vendor (e.g., Apple, Samsung).
Operating system (e.g., iOS, Android).
Operating system version (e.g., iOS 15, iOS 16).

In some embodiments, the device-specific identification features may be calculated, with respect to each of the end-devices, over one or more predefined measuring periods of between 1 minute and 365 days. In some embodiments, the predefined measuring period is 1 hour. In some embodiments, the predefined measuring period is 24 hours.

In some embodiments, one or more of these feature in a feature set associated with a unique device may be indicated as ‘UNKNOWN’ when the value(s) associated with these one or more features cannot be ascertained.

In some embodiments, these features may be extracted, when available, from the telemetry data associated with each unique device (as captured in step 302), such as, but not limited to, Internet Protocol (IP) addresses, Media Access Control (MAC) addresses, open port data, Dynamic Host Control Protocol (DHCP) data, Hypertext Transfer Protocol (HTTP) data, multicast Domain Name Service (mDNS), DNS data, DNS-SD data, Universal Plug and Play (UPnP) data, and File Transfer Protocol (FTP) data.

For example, the MAC address can be used to identify a vendor, because every vendor has its own assigned range of MAC addresses. The list of open ports on a device can be used to identify running services on the device. The UPnP and mDNS data can identify a device's manufacturer or model name, and can identify the capabilities of the device (e.g., a network storage device, printer device etc.). DHCP data identifies the host name, class ID, and a system sequence of numbers, which can be used to identify an operating system name and version running on the device. HTTP data from authentication and/or administration interfaces to a device can be used to assist in identifying the type of device. For example, the HTTP data can include keywords that can be useful for device type identification.

In some embodiments, the instructions of data traffic analysis module 206a may cause system 200 to further convert the input telemetry data into a form that is suitable for use in training the machine learning model. For example, the input data can be processed into a quantitative vector indicating the value associated with each feature.

With continuous reference to step 308, the instructions of data traffic analysis module 206a may cause system 200 to further calculate additional traffic flow-related features with respect to each unique device including, but not limited to:

Packets in-rate: Total number of data packets received within a specified time window.
Bytes in-rate: Total number of bytes received within a specified time window.
Packets out-rate: Total number of data packets transmitted within a specified time window.
Bytes out-rate: Total number of bytes transmitted within a specified time window.
Packet inter-arrival times: Average, minimum, maximum, variance, and/or distribution of the duration between packet arrivals.
DPS: Mean, minimum, maximum, variance, and/or distribution of download packet size.
UPS: Mean, minimum, maximum, variance, and/or distribution of upload packet size.
DPR: Mean, minimum, maximum, variance, and/or distribution of download packet rate.
UPR: Mean, minimum, maximum, variance, and/or distribution of upload packet rate.
RR: Ratio between the mean, minimum, maximum, variance, and/or distribution of the rate of download to upload packets.
RS: Ratio between the mean, minimum, maximum, variance, and/or distribution of the in bytes rate to out bytes rate.
Data throughput: Total, mean, minimum, maximum, and/or variance of data traffic flow.
Protocols used: the type and number of protocols used within a specified time window, per ISO layer.
Type of contacted servers.
Source and destination port numbers.
Unencrypted TLS handshake information: The type and number of used cyphersuites, extension and key lengths.

In some embodiments, the traffic flow features may be calculated, with respect to each of the end-devices, over one or more predefined measuring periods of between 1 minute and 365 days. In some embodiments, the predefined measuring period is 1 hour. In some embodiments, the predefined measuring period is 24 hours.

In step 310, the instructions of machine learning module 206b may cause system 200 to construct a training dataset comprising a plurality of sets of features, as calculated and extracted in steps 304-308 with respect to each unique device for which data flow samples were observed, captured, and preprocessed in step 302.

In a non-limiting example, a training dataset of the present disclosure may comprise one or more of the sets of features calculated and determined in steps 304-304, with respect to each uniquely identified device, including one or more of the following feature set categories:
Usage-based features calculated as detailed with reference to step 304 above.
Wireless link metrics-related features calculated as detailed with reference to step 306 above.
Device-specific identification features calculated as detailed with reference to step 308 above.
Traffic flow-related features calculated as detailed with reference to step 308 above.

In some embodiments, each feature set may be labeled with a label indicating one or more ‘ground truth’ device attributes of the unique device associated with the particular feature set, such as one or more of the following device attribute categories:
Device type (e.g., desktop computer, laptop computer, smartphone, tablet, etc.).
Device manufacture (e.g., Apple, Samsung).
Device make or brand (e.g., iPhone, Galaxy).
Device model (e.g., iPhone 13, iPhone 14).
Device operating system (e.g., iOS, Android).
Device operating system version (e.g. iOS 15, iOS 16).

However, other device attributes which may be used to categorize an end-device may be used in addition and/or in lieu of the above-enumerated attributes.

In some embodiments, a training dataset of the present disclosure comprises a set of labeled examples, from which a machine learning model of the present disclosure may be trained to build a set of classification rules, to classify unseen examples. In some embodiments, the labeling process may be manual i.e., performed by a specialist assigning the correct ‘ground truth’ label or labels to each feature set. However, in some embodiments, a training dataset of the present disclosure may be labeled using semi-automated or automated methods. For example, in some embodiments, a training dataset may comprise a portion of labeled data, combined with unlabeled features.

With continued reference to FIG. 3, in step 312, the instructions of machine learning module 206b may cause system 200 to train a machine learning model, such as classification model 206c, on the training dataset constructed in step 310.

In step 314, the training process of step 312 obtains a trained machine learning model, which may be embodied in classification model 206c, configured to perform automated, real-time classification of end-devices.

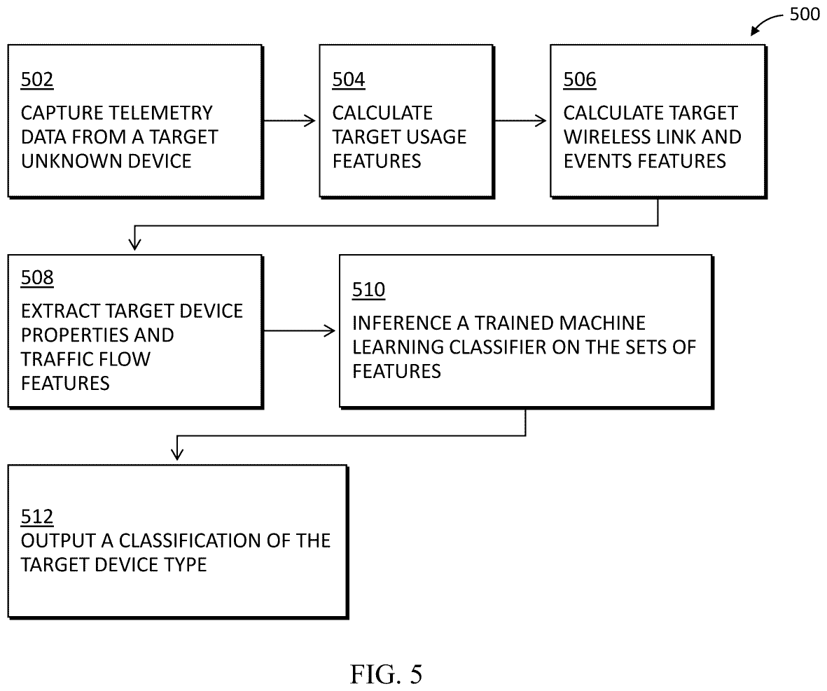

The instructions of system 200 will now also be discussed with reference to the flowchart of FIG. 5, which illustrates the functional steps in a method 500 for automated, real-time, device classification, by inferencing a trained machine learning classifier, such as classification model 206c, in accordance with various aspects of the present disclosure. FIG. 5 provides an overview of a pipeline for inferencing a machine learning classifier of the present disclosure, such as classification model 206c, according to some embodiments.

The various steps of method 500 may either be performed in the order they are presented or in a different order (or even in parallel), as long as the order allows for a necessary input to a certain step to be obtained from an output of an earlier step. In addition, the steps of method 500 may be performed automatically (e.g., by system 200 of FIG. 2), unless specifically stated otherwise.

Method 500 begins in step 502, wherein the instructions of network traffic monitor 208 may cause system 200 to capture target telemetry data 220 associated with data traffic flows over a monitored communications networks, wherein the data traffic flows are associated with an unknown target end-device, operating within the monitored network.

In some embodiments, the telemetry data 220 may be captured over one or more predefined measuring periods of between 1 minute and 365 days. In some embodiments, the predefined measuring period is 1 hour. In some embodiments, the predefined measuring period is 24 hours.

For example, with reference to FIG. 1, an unknown target device, such as STA 104 within LAN 116, may initiate a data traffic session with a content provider, e.g., one of service platforms 120-126. In some embodiments, in order to fetch the service, the STA 104 may open one or more connections, e.g., two or more parallel connections to fetch the multiple resources comprising the requested service. In some embodiments, network traffic monitor 208 may continuously or periodically monitor and sample the one or more established connections, e.g., 1, 2, 3, 4, 5 or more connections (which may be referred to as the ‘connection context’), to capture target data traffic flows associated with the service being provided to STA 104.

In step 504, the instructions of data traffic analysis module 206 may cause system 200 to receive the telemetry data 220 captured in step 502 for further processing.

In some embodiments, the instructions of data traffic analysis module 206 may cause system 200 to classify relevant portions of telemetry data 220 into one or more of a predetermined set of service types or categories, e.g., media streaming, file downloading, file uploading, online gaming, conferencing, social network usage, internet browsing, VPN session, music streaming, electronic mail usage, and/or remote desktop session.

In some embodiments, the instructions of data traffic analysis module 206 may then cause system 200 to calculate one or more sets of usage features for the target device from the input telemetry data 220, as detailed with reference to step 304 in FIG. 3.

In some embodiments, the features may be calculated over one or more predefined measuring periods of between 1 minute and 365 days. In some embodiments, the predefined measuring period is 1 hour. In some embodiments, the predefined measuring period is 24 hours.

In step 506, the instructions of data traffic analysis module 206 may then cause system 200 to calculate one or more sets of wireless link metrics-related features for the target device from the input telemetry data 220, as detailed with reference to step 306 in FIG. 3.

In some embodiments, the features may be calculated over one or more predefined measuring periods of between 1 minute and 365 days. In some embodiments, the predefined measuring period is 1 hour. In some embodiments, the predefined measuring period is 24 hours.

In step 508, the instructions of data traffic analysis module 206 may then cause system 200 to calculate one or more sets of device-specific identification features calculated, as well as, optionally, traffic flow-related features, calculated as detailed with reference to step 308 in FIG. 3.

In some embodiments, the features may be calculated over one or more predefined measuring periods of between 1 minute and 365 days. In some embodiments, the predefined measuring period is 1 hour. In some embodiments, the predefined measuring period is 24 hours.

In step 510, the instructions of machine learning module 206b may cause system 200 to inference classification model 206c on the sets of features calculated in steps 504-508 from the telemetry data 220.

In step 512, the instructions of classification model 206c may cause system 200 to output the inferencing results of step 510 as a classification 222 of the target unknown device.

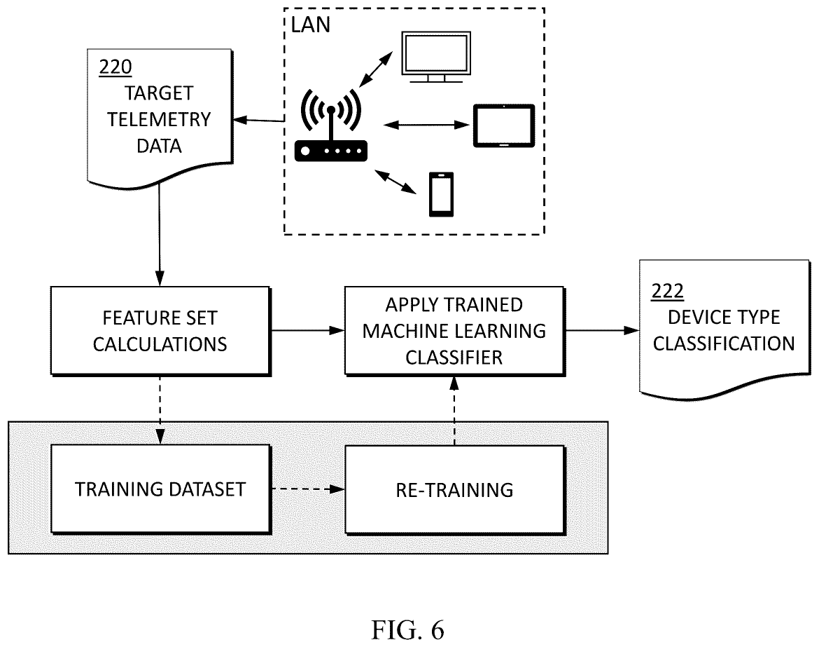

FIG. 6 illustrates an inferencing pipeline of a classification model 206c of the present disclosure, using a machine learning model trained as detailed above. Target telemetry data 220 captured in real-time is used to extract sets of features, on which the trained machine learning classifier is inferenced. The classifier's output indicates a classification of an end-device. Certain implementations may optionally allow the model to be updated in real-time, by continuously re-training the model using features and label obtained during real-time inference of the model.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Rather, the computer readable storage medium is a non-transient (i.e., not-volatile) medium.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, a field-programmable gate array (FPGA), or a programmable logic array (PLA) may execute the computer readable program instructions by utilizing state information of the computer readable program instructions to personalize the electronic circuitry, in order to perform aspects of the present invention. In some embodiments, electronic circuitry including, for example, an application-specific integrated circuit (ASIC), may be incorporate the computer readable program instructions already at time of fabrication, such that the ASIC is configured to execute these instructions without programming.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In the description and claims, each of the terms “substantially,” “essentially,” and forms thereof, when describing a numerical value, means up to a 20% deviation (namely, ±20%) from that value. Similarly, when such a term describes a numerical range, it means up to a 20% broader range—10% over that explicit range and 10% below it).

In the description, any given numerical range should be considered to have specifically disclosed all the possible subranges as well as individual numerical values within that range, such that each such subrange and individual numerical value constitutes an embodiment of the invention. This applies regardless of the breadth of the range. For example, description of a range of integers from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 4, and 6. Similarly, description of a range of fractions, for example from 0.6 to 1.1, should be considered to have specifically disclosed subranges such as from 0.6 to 0.9, from 0.7 to 1.1, from 0.9 to 1, from 0.8 to 0.9, from 0.6 to 1.1, from 1 to 1.1 etc., as well as individual numbers within that range, for example 0.7, 1, and 1.1.

The descriptions of the various embodiments of the present invention have been presented for purposes of illustration, but are not intended to be exhaustive or limited to the explicit descriptions. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the description and claims of the application, each of the words “comprise,” “include,” and “have,” as well as forms thereof, are not necessarily limited to members in a list with which the words may be associated.

Where there are inconsistencies between the description and any document incorporated by reference or otherwise relied upon, it is intended that the present description controls.

1. A system comprising:
at least one hardware processor; and
a non-transitory computer-readable storage medium having stored thereon program instructions, the program instructions executable by the at least one hardware processor to:
receive, at a wireless network interface, telemetry data from a plurality of uniquely-identified end-devices in multiple communication networks, wherein the telemetry data is captured with respect to each of said end-devices over one or more measuring periods of a predefined duration,
process said telemetry data to calculate features indicating usage patterns associated with each of said end-devices, and
at a training stage, train a machine learning model on a training dataset comprising:
(i) said features indicating usage patterns associated with each of said end-devices, and
(ii) labels indicating one or more attributes associated with each of said end-devices,
to obtain a trained machine learning classifier configured to predict said one or more attributes with respect to an unknown target end-device, by applying said trained machine learning model to telemetry data obtained from said unknown target end-device.

2. The system of claim 1, wherein said attributes are selected from the group consisting of: type of end-device, manufacture of end-device, make or brand of end-device, model of end-device, operating system of end-device, or operating system version of end-device.

3. The system of claim 1, wherein said features indicating usage pattern with respect to each of said end-devices are calculated based on at least one of the following usage categories: total usage time of the end-device during each of said measuring periods; total usage time of the end-device during each of said measuring periods, separately with respect to each one of a predefined set of service categories; number of instances of usage of the end-device during each of said measuring periods; or number of instances of usage of the end-device during each of said measuring periods, separately with respect to each one of said predefined set of service categories.

4. The system of claim 3, wherein said predefined set of service categories is selected from the group consisting of: media streaming, file downloading, file uploading, online gaming, conferencing, social network usage, internet browsing, VPN session, music streaming, electronic mail usage, or remote desktop session.

5. The system of claim 1, wherein said training dataset further comprises features indicating one or more wireless link metrics associated with each of said end-devices, and wherein said wireless link metrics are selected from the group consisting of: received signal strength indication (RSSI), Wi-Fi standard, Wi-Fi RF band, Wi-Fi channel, Wi-Fi channel bandwidth, Wi-Fi channel bitrate, retransmission rate, failure rate, Wi-Fi channel load, Wi-Fi channel interference, or Wi-Fi channel background noise.

6. The system of claim 1, wherein said training dataset further comprises features indicating, with respect to each of said end-devices, one or more event categories occurring during each of said measuring periods, and wherein said event categories are selected from the group consisting of: count and number of instances of disconnections during each of said measuring periods, authentication failures during each of said measuring periods, ADDBA requests during each of said measuring periods, and count and duration of instances of bitrate or packet rate falling below a predetermined threshold during each of said measuring periods.

7. The system of claim 1, wherein said predefined duration is selected from the group consisting of the following time periods: 1 hour or 24 hours.

8. A computer-implemented method comprising:
receiving, at a wireless network interface, telemetry data from a plurality of uniquely-identified end-devices in multiple communication networks, wherein the telemetry data is measured with respect to each of said end-devices over a one or more measuring periods of a predefined duration;
processing said telemetry data to calculate features indicating usage patterns associated with each of said end-devices; and
at a training stage, training a machine learning model on a training dataset comprising:
(i) said features indicating usage patterns associated with each of said end-devices, and
(ii) labels indicating one or more attributes associated with each of said end-devices,
to obtain a trained machine learning classifier configured to predict said one or more attributes with respect to an unknown target end-device, by applying said trained machine learning model to telemetry data obtained from said unknown target end-device.

9. The computer-implemented method of claim 8, wherein said attributes are selected from the group consisting of: type of end-device, manufacture of end-device, make or brand of end-device, model of end-device, operating system of end-device, or operating system version of end-device.

10. The computer-implemented method of claim 8, wherein said features indicating usage pattern with respect to each of said end-devices are calculated based on at least one of the following usage categories: total usage time of the end-device during each of said measuring periods; total usage time of the end-device during each of said measuring periods, separately with respect to each one of a predefined set of service categories; number of instances of usage of the end-device during each of said measuring periods; or number of instances of usage of the end-device during each of said measuring periods, separately with respect to each one of said predefined set of service categories.

11. The computer-implemented method of claim 10, wherein said predefined set of service categories is selected from the group consisting of: media streaming, file downloading, file uploading, online gaming, conferencing, social network usage, internet browsing, VPN session, music streaming, electronic mail usage, or remote desktop session.

12. The computer-implemented method of claim 8, wherein said training dataset further comprises features indicating one or more wireless link metrics associated with each of said end-devices, and wherein said wireless link metrics are selected from the group consisting of: received signal strength indication (RSSI), Wi-Fi standard, Wi-Fi RF band, Wi-Fi channel, Wi-Fi channel bandwidth, Wi-Fi channel bitrate, retransmission rate, failure rate, Wi-Fi channel load, Wi-Fi channel interference, or Wi-Fi channel background noise.

13. The computer-implemented method of claim 8, wherein said training dataset further comprises features indicating, with respect to each of said end-devices, one or more event categories occurring during said predefined measuring period, and wherein said event categories are selected from the group consisting of: count and number of instances of disconnections during each of said measuring periods, authentication failures during each of said measuring periods, ADDBA requests during each of said measuring periods, and count and duration of instances of bitrate or packet rate falling below a predetermined threshold during each of said measuring periods.

14. The computer-implemented method of claim 8, wherein said predefined duration is selected from the group consisting of the following time period: 1 hour or 24 hours.

15. A computer program product comprising a non-transitory computer-readable storage medium having program instructions embodied therewith, the program instructions executable by at least one hardware processor to:
receive, at a wireless network interface, telemetry data from a plurality of uniquely-identified end-devices in multiple communication networks, wherein the telemetry data is captured with respect to each of said end-devices over one or more measuring periods of a predefined duration;
process said telemetry data to calculate features indicating usage patterns associated with each of said end-devices; and
(i) at a training stage, train a machine learning model on a training dataset comprising:
(ii) said features indicating usage patterns associated with each of said end-devices, and
labels indicating one or more attributes associated with each of said end-devices,
to obtain a trained machine learning classifier configured to predict said one or more attributes with respect to an unknown target end-device, by applying said trained machine learning model to telemetry data obtained from said unknown target end-device.

16. The computer program product of claim 15, wherein said attributes are selected from the group consisting of: type of end-device, manufacture of end-device, make or brand of end-device, model of end-device, operating system of end-device, or operating system version of end-device.

17. The computer program product of claim 15, wherein said features indicating usage pattern with respect to each of said end-devices are calculated based on at least one of the following usage categories: total usage time of the end-device during each of said measuring periods; total usage time of the end-device during each of said measuring periods, separately with respect to each one of a predefined set of service categories; number of instances of usage of the end-device during each of said measuring periods; or number of instances of usage of the end-device during each of said measuring periods, separately with respect to each one of said predefined set of service categories, and wherein said predefined set of service categories is selected from the group consisting of: media streaming, file downloading, file uploading, online gaming, conferencing, social network usage, internet browsing, VPN session, music streaming, electronic mail usage, or remote desktop session.

18. The computer program product of claim 15, wherein said training dataset further comprises features indicating one or more wireless link metrics associated with each of said end-devices, and wherein said wireless link metrics are selected from the group consisting of: received signal strength indication (RSSI), Wi-Fi standard, Wi-Fi RF band, Wi-Fi channel, Wi-Fi channel bandwidth, Wi-Fi channel bitrate, retransmission rate, failure rate, Wi-Fi channel load, Wi-Fi channel interference, or Wi-Fi channel background noise.

19. The computer program product of claim 15, wherein said training dataset further comprises features indicating, with respect to each of said end-devices, one or more event categories occurring during each of said measuring periods, and wherein said event categories are selected from the group consisting of: count and number of instances of disconnections during each of said measuring periods, authentication failures during each of said measuring periods, ADDBA requests during each of said measuring periods, and count and duration of instances of bitrate or packet rate falling below a predetermined threshold during each of said measuring periods.

20. The computer program product of claim 15, wherein said predefined duration is selected from the group consisting of the following time periods: 1 hour or 24 hours.
